(19) United States
(12) Patent Application Publication
(10) Pub. No.: US 2019/0129662 A1
(43) Pub. Date: May 2, 2019

(54) INFORMATION PROCESSING APPARATUS, IMAGE FORMING APPARATUS AND INFORMATION PROCESSING METHOD CAPABLE OF CALLING FUNCTIONS OF PLURAL SERVERS

(71) Applicant: KYOCERA Document Solutions Inc., Osaka (JP)

(72) Inventors: Takashi OGUMA, Osaka (JP); Masato HIROTA, Osaka (JP); Toru YASUI, Osaka (JP); Toshitsugu NISHIMI, Osaka (JP); Chikara YUKI, Osaka (JP)

(73) Assignee: KYOCERA Document Solutions Inc., Osaka (JP)

(21) Appl. No.: 16/147,011

(22) Filed: Sep. 28, 2018

(30) Foreign Application Priority Data
Oct. 26, 2017 (JP) 2017-207290

(51) Int. Cl. G06F 3/12; H04L 29/06

(52) U.S. Cl. CPC G06F 3/1222; H04L 63/08; G06F 3/1238; G06F 3/1204; G06F 3/1285

(57) ABSTRACT

Provided is an information processing apparatus that calls functions of a plurality of servers without performing authentication every time. An image forming apparatus of an information processing system is an information processing apparatus capable of calling functions of a plurality of servers. An integrated-arrangement unit arranges instruction areas in one application for acquiring instructions for calling functions from any one of a plurality of servers. An authentication-executing unit, in the case where authentication is required for a server corresponding to the instruction areas arranged by the integrated-arrangement unit, performs authentication with that server. An authentication-state-changing unit controls the authentication state authenticated by the authentication-executing unit in correlation with the application and/or the function.

### INCORPORATION BY REFERENCE

This application is based on and claims the benefit of priority from Japanese Patent Application No. 2017-207290 filed on Oct. 26, 2017, the contents of which are hereby incorporated by reference.

### BACKGROUND

The present disclosure relates to an information processing apparatus, an image forming apparatus and an information processing method, and more particularly, to an information processing apparatus, an image forming apparatus and an information processing method capable of calling the functions of plural servers.

Conventionally, there have been information processing apparatuses including image forming apparatuses such as multifunctional peripherals (MFP) or the like capable of printing text and images.

In addition, as a typical technology, there are computing apparatuses that can collectively set parameters without being conscious of the types of apparatuses being set, even in the case where the types of the respective apparatuses for which parameters are being set differ. This kind of computing apparatus integrates two or more user interfaces from among a plurality of user interfaces. This is for two or more of a plurality of peripheral computing apparatuses having user interfaces that require user input. Moreover, the computing apparatus copies at least one user input of a plurality of user interfaces based on the integrated user interfaces. Then, the computing apparatus is configured so as to execute one or more instructions so that, based on the integrated user interfaces, the copied user settings are output to send to two or more of the plurality of peripheral computing apparatuses.

In other words, in this typical technology, user input is simply copied and transmitted to a plurality of apparatuses.

### SUMMARY

The information processing apparatus according to the present disclosure is an information processing apparatus capable of calling functions of a plurality of servers. The information processing apparatus includes an integrated-arrangement unit, an authentication-executing unit, and an authentication-state-changing unit. The integrated-arrangement unit arranges instruction areas in one application for acquiring instructions for calling functions from any one of a plurality of servers. The authentication-executing unit, in the case where authentication is required in the function for a server corresponding to the instruction areas arranged by the integrated-arrangement unit, performs authentication with that server. The authentication-state-changing unit controls the authentication state authenticated by the authentication-executing unit in correlation with the application and/or the function.

The information processing method according to the present disclosure is an information processing method that is executed by an information processing apparatus capable of calling functions of a plurality of servers. The information processing method causes the information processing apparatus to arrange instruction areas in one application for acquiring instructions for calling the functions from any one of the plurality of servers. The information processing method, in the case where authentication is required in the function for a server corresponding to the arranged instruction areas, causes the information processing apparatus to perform authentication with that server. The information processing method causes the information processing apparatus to control the authenticated authentication state in correlation with the application and/or the function.

### BRIEF DESCRIPTION OF THE DRAWINGS

FIG. 1 is a system configuration diagram of an information processing system of an embodiment according to the present disclosure.

FIG. 2 is a block diagram illustrating control configuration of an image forming apparatus illustrated in FIG. 1.

FIG. 3 is a block diagram illustrating the functional configuration of the information processing system illustrated in FIG. 1.

FIG. 4 is a flowchart of an application execution process of an embodiment according to the present disclosure.

FIG. 5 is an example of a screen of an application according to the application execution process illustrated in FIG. 4.

FIG. 6 is a concept diagram of function calling according to the application execution process illustrated in FIG. 4.

FIG. 7 is an example of a screen of an application of another embodiment according to the present disclosure.

### DETAILED DESCRIPTION

### Embodiment

### [System Configuration of Information Processing System X]

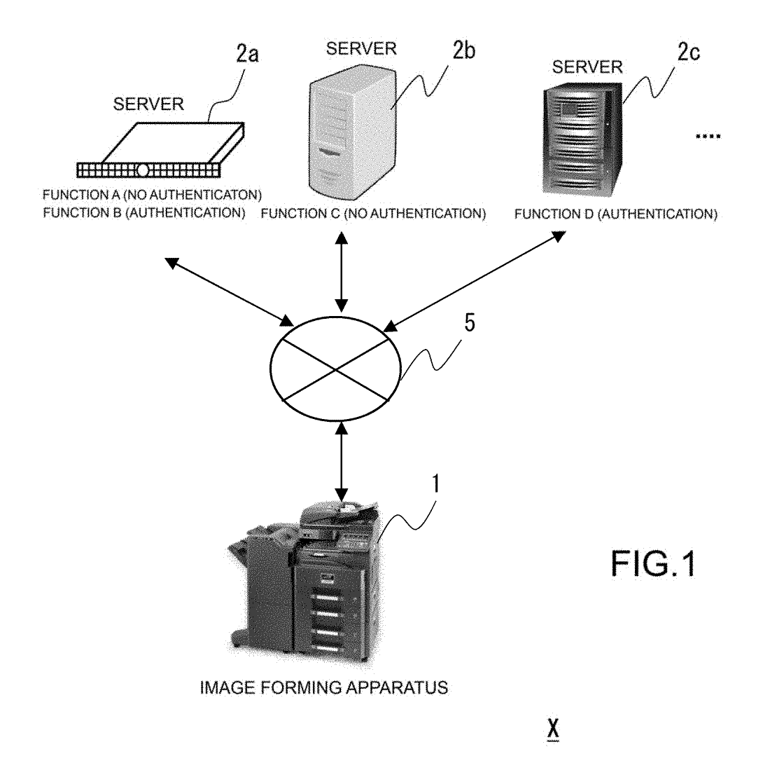

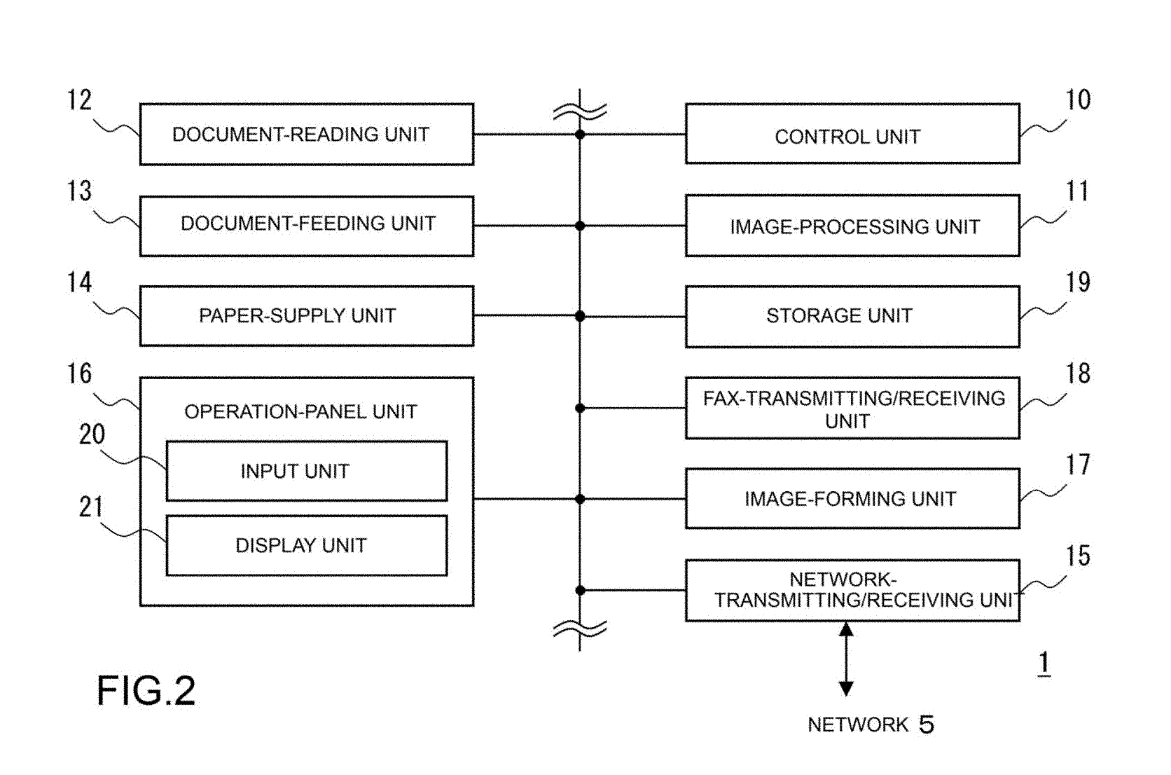

First, the system configuration of information processing system X of an embodiment according to the present disclosure will be explained with reference to FIG. 1 to FIG. 3.

In the information processing system X of this embodiment, an image forming apparatus 1 and a plurality of servers 2a, 2b, 2c, . . . are connected by a network 5.

Incidentally, in the following, when referring to any one of the servers 2a, 2b, 2c, . . . the server will simply be referred to as “server 2”.

The image forming apparatus 1 is an information processing apparatus such as a MFP, a network scanner, a document scanner, a network FAX, a printer with a scanner function, and the like. The image forming apparatus 1 is capable of installing and executing application software (application, hereinafter, simply referred to as an “application”).

In addition, in this embodiment, the image forming apparatus 1 is capable of calling the functions of a plurality of servers 2 via this application. As a result, the image forming apparatus 1 is able to use various functions from the application. Moreover, the image forming apparatus 1 may be capable of instructing the execution of a “workflow” that sequentially executes various processes by combining these various functions. As this workflow, for example, it may be possible to perform image processing, optical character recognition (OCR) processing, classification processing and the like. Furthermore, as the workflow, after OCR processing, classification processing or the like, it may also be possible to perform a transmitting process for transmitting to electronic mail (e-mail), a shared folder (saving folder, document box), a document management system (DMS) for a business or office work, and the like.

The server 2 is an information processing apparatus capable of transmitting and receiving various data with the image forming apparatus 1, and capable of using various functions according to instructions from the image forming apparatus 1. More specifically, the server 2 may be a general-purpose machine, personal computer (PC), server, network attached storage (NAS), or the like. In addition, the server 2 may perform user authentication (hereinafter, simply referred to as “authentication”) including a login process with the image forming apparatus 1.

In the example in FIG. 1, of the servers 2, for example, server 2a is able to execute the processing of function A and function B. Server 2b is able to execute the processing of function C. Server 2c is able to execute the processing of function D. In other words, one server 2 may be capable of executing a process of a plurality of functions.

Moreover, the server 2 may require authentication for each function. In this case, the server 2 may execute processing related to a function corresponding to an instruction from the image forming apparatus 1 only in the case where an authenticated state is reached for a function that requires authentication. Furthermore, in the case of a function that does not require authentication, the server 2 may execute processing related to that function according to an instruction from the image forming apparatus without performing authentication. In the example in FIG. 1, for example, function B and function D require authentication, and function A and function C do not require authentication.

Incidentally, configuration may be such that authentication is performed in units of each server 2. In addition, information processing system X may include even a larger number of servers 2, or may include a server 2 on a so-called “cloud”, or the like.

Moreover, in this embodiment, the functions in each server 2 that require authentication do not need to support single sign-on (SSO) using a unified authentication account name and password. In other words, authentication information may differ for each server 2 unit. In addition, authentication may require different authentication information for each function.

In this embodiment, network 5 is an intranet such as a local area network (LAN), a wide area network (WAN) or the like such as the Internet, mobile telephone network, or the like. In the case where the network 5 is a WAN, the network 5 may be capable of connecting to another server 2 on a so-called “cloud” via a router, gateway, or the like. In addition, the network 5 may constitute a virtual private network (VPN).

Moreover, the image forming apparatus 1 includes an image-processing unit 11, a document-reading unit 12, a document-feeding unit 13, a paper-supply unit 14, a network-transmitting/receiving unit 15, an operation-panel unit 16, an image-forming unit 17, a FAX-transmitting/receiving unit 18, a storage unit 19 and the like. Each unit is connected to a control unit 10, and operation is controlled by the control unit 10.

The control unit 10 is an information-processing unit such as a general purpose processor (GPP), a central processing unit (CPU), a micro processing unit (MPU), a digital signal processor (DSP), a graphics processing unit (GPU), an application specific processor (ASIC), or the like.

The control unit 10 can cause the operation as each unit of a functional block described later by reading a control program stored in the ROM or HDD of the storage unit 19, developing the control program in the RAM, and executing the control program.

Moreover, the control unit 10 performs overall control of the apparatus according to specific instruction information inputted from an external terminal or the operation-panel unit 16.

The image-processing unit 11 is a control-arithmetic unit such as a digital signal processor (DSP), a graphics processing unit (GPU) and the like. The image-processing unit 11 performs specific image processing of image data. This specific image processing, for example, may be processing such as enlargement/reduction, density adjustment, gradation adjustment, image improvement, and the like.

In addition, the image-processing unit 11 stores an image read by the document-reading unit 12 in the storage unit 19 as printing data. At this time, the image-processing unit 11 is also capable of converting the printing data into a file of an electronic document such as PDF or the like, or image data such as TIFF and the like. Moreover, the image-processing unit 11 may be capable of executing at least part of an OCR process.

The document-reading unit 12 is a unit for reading (scanning) a set document. In addition, the document-reading unit 12 is arranged in the upper portion of the main body of the image forming apparatus 1.

The document-reading unit 12, for example, includes a scanner, a platen glass, and a document-reading slit. In the case of reading a document that is placed on the platen glass, the document-reading unit 12 moves the scanner to a position facing the platen glass. Then, the document-reading unit 12 acquires image data by reading while scanning the document placed on the platen glass. The document-reading unit 12 outputs the acquired image data to the control unit 10.

Moreover, in the case of reading a document that is fed from the document-feeding unit 13, the document-reading unit 12 moves the scanner to a position facing the document-reading slit. Then, the document-reading unit 12 acquires image data by reading the document via the document-reading slit in synchronization with the conveying operation of the document by the document-feeding unit 13. The document-reading unit 12 outputs the acquired image data to the control unit 10.

The document-feeding unit 13 is a unit that feeds a document to be read by the document-reading unit 12. The document-feeding unit 13 is arranged in the upper portion of the document-reading unit 12.

The document-feeding unit 13 includes a document-placement unit and a document-conveying mechanism. The document-feeding unit 13 sequentially feeds a document that is placed in the document-placement unit to the document-reading unit 12 one sheet at a time by the document-conveying mechanism.

The paper-supply unit 14 is a unit that feeds recording paper toward the image-forming unit 17 one sheet at a time. The paper-supply unit 14 is included in the main body.

The network-transmitting/receiving unit 15 is a network connecting unit that includes an LAN board and a wireless transceiver and the like for connecting to the network 5.

The network-transmitting/receiving unit 15 transmits and receives data by a data-communication line, and transmits and receives voice signals by a voice telephone line.

The operation-panel unit 16 is a unit that acquires instructions from a user, and displays the state and the like of the image forming apparatus 1.

The configuration of the operation-panel unit 16 will be described later.

The image-forming unit 17 is a unit that, according to an output instruction from a user, performs image formation on recording paper from data that is stored in the storage unit 19, read by the document-reading unit 12, or acquired from an external terminal.

The image-forming unit 17 includes a photosensitive drum, an exposing unit, a developing unit, a transferring unit, a fixing unit and the like. The image-forming unit 17 records a toner image on recording paper by executing an image-forming process that includes charging, exposing, developing, transferring and fixing.

The FAX-transmitting/receiving unit 18 is a unit that performs transmission and reception of facsimiles. The FAX-transmitting/receiving unit 18 is able to receive a facsimile from another FAX apparatus via a voice line or the like, store the facsimile in the storage unit 19, and cause the image-forming unit 17 to form an image. In addition, the FAX-transmitting/receiving unit 18 is able to convert a document read by the document-reading unit 12 or data of a network FAX that is transmitted from an external terminal to image data, and transmit a facsimile to another FAX apparatus via a voice line or the like.

The storage unit 19 is a storage unit that uses a recording medium such as a semiconductor memory such as a read only memory (ROM), a random access memory (RAM), a flash memory and the like, or a hard disk drive (HDD) and the like.

The RAM of the storage unit 19, may store storage contents even in a power-saving state by a function such as self refresh or the like.

A control program for performing operation control of the image forming apparatus 1 is stored in the ROM, flash memory or HDD of the storage unit 19. This control program includes programs such as an operating system (OS), various applications and the like, and data. The OS, various applications and the like include a function of enabling a user to operate the user's own apparatus via a graphical user interface (GUI) from the operation-panel unit 16 or another terminal. In addition, this control program includes a World Wide Web (WWW) server, middleware, and the like that operate on the OS.

In addition to this, the storage unit 19 may store user account settings. Moreover, the storage unit 19 may include an area for storage folders (document box) for each user.

Furthermore, the operation-panel unit 16 includes an input unit 20 and a display unit 21.

The input unit 20 includes a touch panel, switches, buttons and the like for acquiring various instructions from a user. The touch panel of the input unit 20, by a resistance film method, electrostatic capacitive method, distortion detection method or the like, detects coordinates and the like on the display unit 21 where a user presses. In addition, the input unit 20 may also be multi-touch compatible.

Moreover, the switches of the input unit 20, for example, are switches such as a start key, numeric key pad, operation mode switch, switches for acquiring instructions for a selected document, and the like. The operation mode may be capable of being switched between modes such as a copy mode, scanner mode and the like. An instruction for a selected document may be an instruction related to printing, transmission, reception and the like.

In addition, the input unit 20 may be capable of acquiring user instructions for respective instruction areas of an application to be described later.

The display unit 21 is a flat display panel such as a liquid-crystal display (LCD), organic electro-luminescence (OEL), field emission display (FED), fluorescent display tube, or the like, a projector, a status display LED, or the like.

The display unit 21 is able to display various operation screens of the GUI. The operation screens include an application screen, a display area displayed in an application for calling functions of the server 2, various buttons, and the like.

Incidentally, in the image forming apparatus 1, the control unit 10 and the image-processing unit 11 may be integrally formed such as a GPU-equipped CPU, a chip-on-module package, or the like.

In addition, the control unit 10 and the image processing unit 11 may incorporate a RAM, a ROM, a flash memory, or the like.

### [Functional Configuration of the Image Forming Apparatus 1]

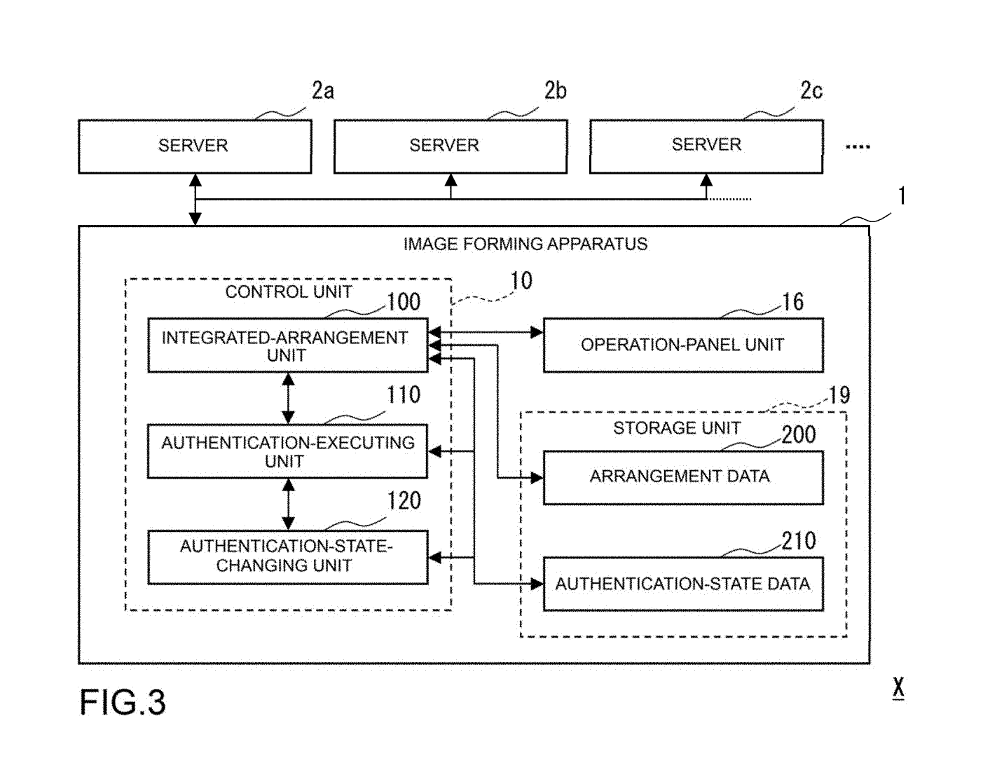

Here, the functional configuration of the image forming apparatus 1 according to an embodiment disclosed in the present disclosure will be explained with reference to FIG. 3.

The control unit 10 includes an integrated-arrangement unit 100, an authentication-executing unit 110, and an authentication-state-changing unit 120.

The storage unit 19 is capable of storing arrangement data 200 and authentication-state data 210.

The integrated-arrangement unit 100 arranges instruction areas that acquire instructions for calling functions of any one of the plurality of servers 2 in one application.

In this embodiment, the integrated-arrangement unit 100, for example, causes a GUI screen of an application installed in the image forming apparatus 1 to be displayed on the display unit 21 of the operation-panel unit 16. In addition, the integrated-arrangement unit 100, for example, arranges instruction areas that instruct processing of a plurality of functions in correspondence to arrangement data 200, and arranges the instruction areas on the screen of one application.

When doing this, the integrated-arrangement unit 100 may respectively arrange instruction areas for functions that require authentication by the authentication-executing unit 110 and instruction areas for functions that do not require authentication on the screen of one application. Moreover, the integrated-arrangement unit 100 may arrange instruction areas, for which the servers 2 corresponding to the functions to be called differ, on the screen of one application. Incidentally, the integrated-arrangement unit 100 may arrange and display instruction areas in the form of tiles, in the form of a list, or the like.

Furthermore, the integrated-arrangement unit 100 may arrange other menus, buttons, and the like, for acquiring user instructions for an application, and for displaying various kinds of information on the screen of one application.

In addition, the integrated-arrangement unit 100 may acquire from the input unit 20 an instruction in an instruction area for calling a function, and actually call the function of the corresponding server 2. When doing this, the integrated-arrangement unit 100 may call functions of different servers 2 for each instruction area.

In the case where authentication is required for a function of a server 2 corresponding to an instruction area arranged by the integrated-arrangement unit 100, the authentication-executing unit 110 performs authentications with that server 2.

In this embodiment, in the case, for example, where a user gives an instruction for an instruction area on the input unit 20 by pressing or the like, the authentication-executing unit 110 connects to the server 2 that executes processing of the function corresponding to the instruction area. When doing this, in the case where authentication is requested by the server 2, the authentication-executing unit 110 acquires authentication information inputted by the user from the input unit 20 or the like, and transmits this information to the server 2 to perform authentication. The authentication-executing unit 110 may set the authentication result and authentication information in authentication-state data 210.

The authentication-state-changing unit 120 controls the authentication state authenticated by the authentication-executing unit 110 in correlation with the application and/or function.

More specifically, the authentication-state-changing unit 120 may keep the authentication state corresponding to a function so that even after calling a function different from that function, authentication will not be required again. In other words, in this embodiment, in the case where authentication has already been performed by the authentication-executing unit 110, the authentication-state-changing unit 120 may, for example, maintain the connection session or the like. As a result, in the case where a user calls the same function, the processing of the function is executed again in the authenticated state. In this way, the authentication-state-changing unit 120 may control the authentication state authenticated by the authentication-executing unit 110 in correlation with the function.

In addition, in this embodiment, the authentication-state-changing unit 120, for example, when terminating execution of an application, disconnects the sessions or the like with the plurality of servers 2 having functions that can be called from the application, and returns to a unauthenticated state. In this way, the authentication-state-changing unit 120 may control the authentication state authenticated by the authentication-executing unit 110 in correlation with an application.

The arrangement data 200 is GUI data of an application installed in the image forming apparatus 1. The arrangement data 200 includes information regarding the instruction areas in the application corresponding to each of the functions of the plurality of servers 2.

More specifically, the arrangement data 200, for example, may be configured by a markup language such as XML, HTML or the like, a macro language, or the like. In addition, the arrangement data 200, for example, may include information regarding each area of the GUI that identifies each of the functions. Moreover, the arrangement data 200, as the type of each area, may include instruction areas corresponding to the functions of the server 2, areas of the GUI components such as buttons, menus and the like. Moreover, the arrangement data 200, as information regarding each of the areas, may include information about appearance such as arrangement positions, size, color, fonts, and the like, the types of user instructions to acquired by the application and the like. Of these, arrangement data 200, as information regarding arrangement positions of the instruction areas, for example, may include ratios of dividing positions, relative positions, and rectangular coordinates of pixel positions in the application. In addition, the arrangement data 200, as information in the instruction areas, may include information about the server 2 to be called and types of functions, the addresses and protocols of the server 2 and functions to be called, data to be transmitted and received, settings and the like. Moreover, the arrangement data 200, as information regarding the instruction areas, may include data and the like described in a macro language or script language indicating the workflow procedure or the like.

In addition, the arrangement data 200, for example, may include, descriptions of buttons or the like that can be displayed on the application screen 300 (application screen) and that instruct specific processes. The buttons may include buttons such as an end (closing) button of the application, a workflow add or change button, and other buttons for setting special printing methods, setting the arrangement of the functions themselves, and the like.

Incidentally, the arrangement data 200, as described in other embodiments described later, may include buttons inside or outside each instruction area, for example, for performing changes to the authentication state of a session related to each of the functions of the server 2.

Authentication-state data 210 is data that indicates the authentication state performed by the authentication-executing unit 110 with the server 2. More specifically, the authentication-state data 210 includes information regarding the authentication state corresponding to each function of the server 2. In addition, the authentication-state data 210, as information regarding this authentication state, may, for example, include information of an “authenticated state” as a state in which authentication is successful and calling a function of the server 2 is possible, and an “unauthenticated state” as an unauthenticated state or authentication failed state. Moreover, the authentication-state data 210, in the case of an authenticated state, may include information regarding the state of a connection session with this function and the like. Information regarding the state of this session may include information such as authentication information related to authentication by a user, connection time from the start of a session connection, time until disconnection, and the like.

Furthermore, in this embodiment, as authentication-state data 210, common information for each function may be used, or different information for each function may be used. In addition, the authentication-state data 210 may also include information for individual authentication that is different for each server 2 or each function to be called. Moreover, the authentication-state data 210 may be encrypted.

Here, the control unit 10, by executing the control program stored in the storage unit 19, is made to function as the integrated-arrangement unit 100, the authentication-executing unit 110, and the authentication-state-changing unit 120.

In addition, each unit of the image forming apparatus 1 described above is a hardware resource that executes the image forming method according to the present disclosure.

Incidentally, part or an arbitrary combination of the functional configurations described above may be configured as hardware such as an IC, programmable logic, or the like.

### [Application Execution Process by the Image Forming Apparatus 1]

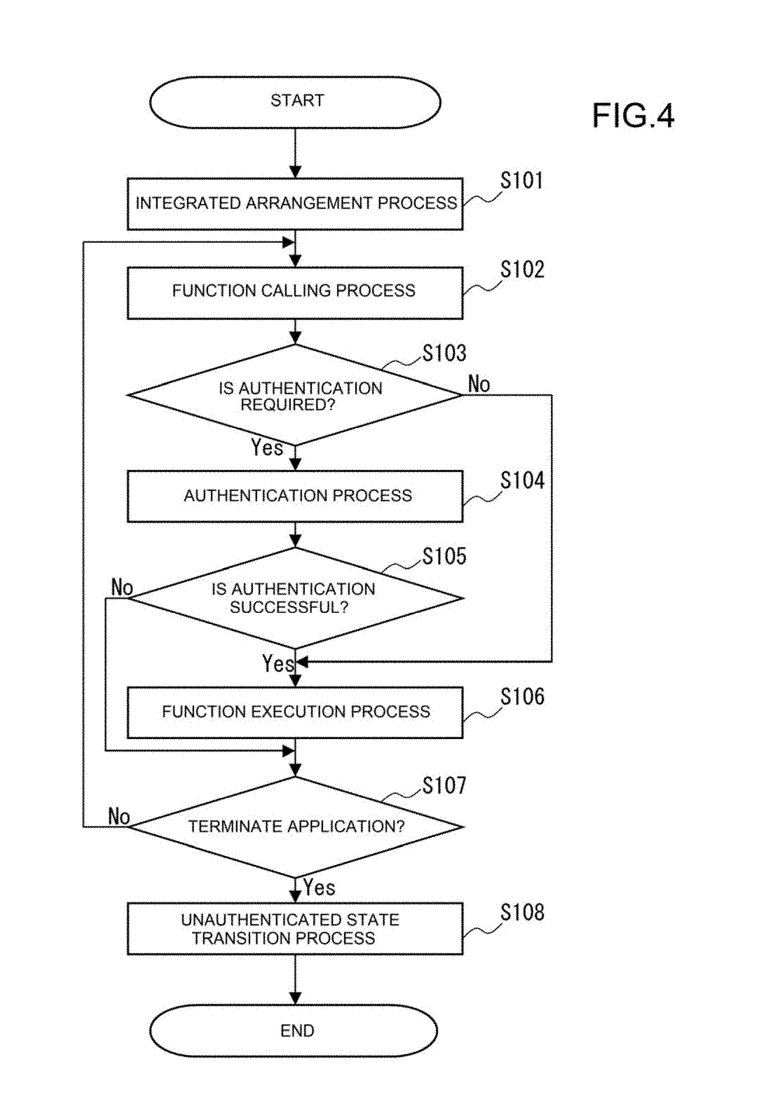

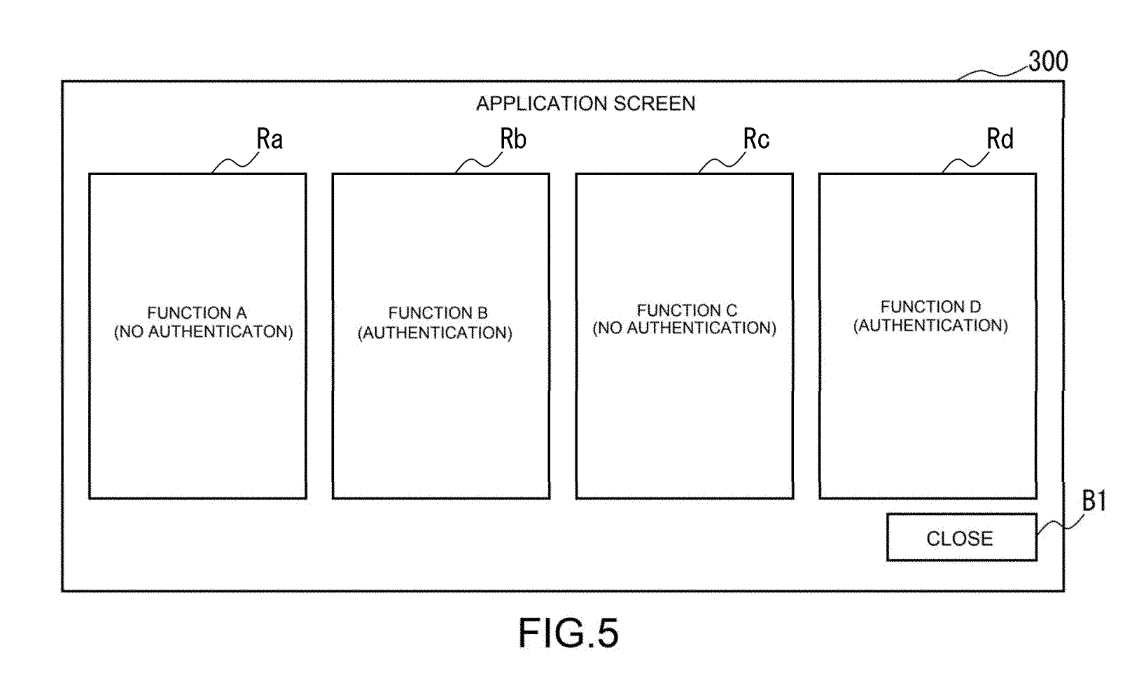

Next, the application execution process by the image forming apparatus 1 of the information processing system X according to an embodiment disclosed in the present disclosure will be explained with reference to FIG. 4 and FIG. 5.

The application execution process of this embodiment is a process of the information processing method executed by the image forming apparatus 1 that is capable of calling functions of a plurality of servers 2. In the application execution process, instruction areas that acquire instructions for calling any one of the functions of the plurality of servers 2 are arranged on the screen of one application and displayed. In addition, in the case where execution of a function is instructed from the instruction area, a connection is made with the corresponding server 2. Then, in the case where authentication is required, authentication is performed with that server 2. Moreover, the authenticated authentication state is controlled in correlation with the application and/or function.

In the application execution process of this embodiment, mainly the control unit 10 executes the program stored in the storage unit 19 by using the hardware resources in cooperation with each unit.

Hereinafter, each step of the application execution process will be explained in detail with reference to the flowchart in FIG. 4.

### (Step S101)

First, the integrated-arrangement unit 100 performs an integrated arrangement process.

When one application is executed, the integrated-arrangement unit 100 displays the screen of that application on the display unit 21.

Here, the integrated-arrangement unit 100 references the arrangement data 200 and arranges and draws an instruction area for each function. When doing this, the integrated-arrangement unit 100 may align and arrange instruction areas that instruct processing of a plurality of functions. In addition, the integrated-arrangement unit 100, for each of the instruction areas, may respectively set functions that require authentication, and functions that do not require authentication. Moreover, the integrated-arrangement unit 100 may respectively set a different server 2 to be called for each instruction area.

Furthermore, the integrated-arrangement unit 100 may arrange buttons, and the like, for terminating an application on the screen of the same application.

To explain this with reference to FIG. 5, an application screen 300 is an example of a screen that is a main screen (home screen) that is displayed by one application. In this example of an application screen 300, the integrated-arrangement unit 100 respectively arranges an instruction area Ra corresponding to a function A, an instruction area Rb corresponding to a function B, an instruction area Rc corresponding to a function C, and an instruction area Rd corresponding to a function D. In addition, the integrated-arrangement unit 100, disconnects a session connection by the authentication-state-changing unit 120, and arranges a “Close” button for terminating the application on the application screen 300.

### (Step S102)

Here, the integrated-arrangement unit 100 performs a function-calling process.

The integrated-arrangement unit 100 acquires instructions by a user selecting and pressing or the like an instruction area in the GUI using the input unit 20. In addition, the integrated-arrangement unit 100 references the arrangement data 200 and determines to perform calling of the selected function for which one of the servers 2.

### (Step S103)

Next, the authentication-executing unit 110 determines whether or not authentication is required. The authentication-executing unit 110 references the authentication-state data 210. Then, the authentication-executing unit 110, when calling a selected function, determines YES in the case where authentication is required in an unauthenticated state that requires authentication with the corresponding server 2. In all other cases, that is, the authentication-executing unit 110 determines NO in an authenticated state for that function, or in the case where authentication is not required for that function.

In the case of YES, the authentication-executing unit 110 advances the process to step S104.

In the case of NO, the authentication-executing unit 110 advances the process to step S106.

### (Step S104)

In the case where authentication is required, the authentication-executing unit 110 performs an authentication process.

The authentication-executing unit 110 references the arrangement data 200. Then, the authentication-executing unit 110 connects to the address of the server 2 related to the function in the selected instruction area, and performs authentication.

More specifically, the authentication-executing unit 110, as this authentication, may, for example, perform a login process or the like. In this login process, the authentication-executing unit 110, as password authentication, may display an authentication screen on the display unit 21 and have the user input authentication information that includes user ID (identification) or account name, a password, and the like from the input unit 20. In addition, the authentication-executing unit 110 may perform authentication using ID-card authentication such as with an IC card, magnetic card or the like, PIN authentication by input of a number having several digits, biometric authentications such as fingerprint authentication, vein authentication, iris authentication, face authentication, or the like, or an authentication that is a combination of the various kinds of authentication, or the like.

The authentication-executing unit 110 sets the authentication result in the authentication-state data 210. When doing this, the authentication-executing unit 110 may also set the authentication information such as the user ID or account name, the password, the ID card data, the pin number, the biometric authentication data, or the like inputted during the login process for each function in the authentication-state data 210. The authentication information included in this authentication-state data 210 may be kept only during execution of the application, may be kept only while the application is installed, or may be kept even after installation.

### (Step S105)

Next, the authentication-executing unit 110 determines whether or not authentication is successful. In the case where authentication is successful, the authentication-executing unit 110 determines YES. In all other cases, the authentication-executing unit 110 determines NO.

In the case of YES, the authentication-executing unit 110 advances the process to step S106.

In the case of NO, the authentication-executing unit 110 advances the process to step S107.

### (Step S106)

Here, the integrated-arrangement unit 100 and the authentication-state-changing unit 120 perform a function-execution process.

The integrated-arrangement unit 100 causes the server 2 or the like to execute the process for the selected function, and acquires the result. The integrated-arrangement unit 100 may reference the arrangement data 200, and cause the corresponding server 2 to execute the process in accordance with the settings for the data, protocol or the like that is to be transmitted and received. In addition, the integrated-arrangement unit 100 may cause the workflow to be executed in accordance with data that is described in the macro language or script language of the corresponding instruction area.

Moreover, at this time, in the case where a session is disconnected due to elapsing of a specified amount of time or for some other reason, the authentication-state-changing unit 120 may perform authentication again using the authentication-state data 210.

With this kind of configuration, a session is maintained during executing of the application. Therefore, when using a function for which authentications has once been performed, it is not necessary to perform authentication again. In other words, the authentication-executing unit 110 is able to control the authentication state in correlation with the function.

In addition, in the case where authentication related to another function is simultaneously required in an instruction area displayed by the integrated-arrangement unit 100, the authentication-state-changing unit 120 may cause authentication to be performed according to stored authentication-state data 210. At that time, the authentication-state-changing unit 120 may transfer this authentication-state data 210 to the other function, and transmit the authentication-state data 210 to the server 2 corresponding to the other function.

Incidentally, configuration may be such that after a specified amount of time has elapsed, the state returns to the unauthenticated state without authentication being performed again automatically.

### (Step S107)

Here, the authentication-state-changing unit 120 determines whether or not there is an instruction to terminate the application. In the case where there is an instruction from a user using the input unit 20 to terminate the application, the authentication-state-changing unit 120 determines YES. The authentication-state-changing unit 120, for example, determine YES in the case where an instruction is given to terminate the application by a “close” button B1 on the application screen 300 in FIG. 5 being pressed, or where an instruction is given to terminate the application from the menu. In all other cases, the authentication-state-changing unit 120 determines NO.

In the case of YES, the authentication-state-changing unit 120 advances the process to step S108,

In the case of NO, the authentication-state-changing unit 120 returns the process to step S102, and continues acquiring instructions by a user to call functions.

### (Step S108)

In the case where there is an instruction to terminate the application, the authentication-state-changing unit 120 performs an unauthenticated-state-transition process.

The authentication-state-changing unit 120 disconnects the connections with all servers 2 in accordance to the termination of the application. More specifically, the authentication-state-changing unit 120, when terminating execution of the application, disconnects the session and the like with the plurality of servers 2 having functions that can be called from the application, and returns to the unauthenticated state. The authentication-state-changing unit 120, sets this in the authentication-state data 210. As a result, the authentication-state-changing unit 120, by the authentication-executing unit 110, is able to control the authentication state in correlation with the application.

Incidentally, in this embodiment, when executing a terminated application again, authentication is performed again. As a result, by performing authentication once during execution of an application, authentication is not necessary again, so it is possible to reduce the time and effort by the user while improving security. Conversely, authentication may be performed according to authentication data, and the state can be automatically transitioned from the unauthenticated state to the authenticated state.

This ends the application execution process according to an embodiment disclosed in this disclosure.

### [Specific Example of the Application Execution Process]

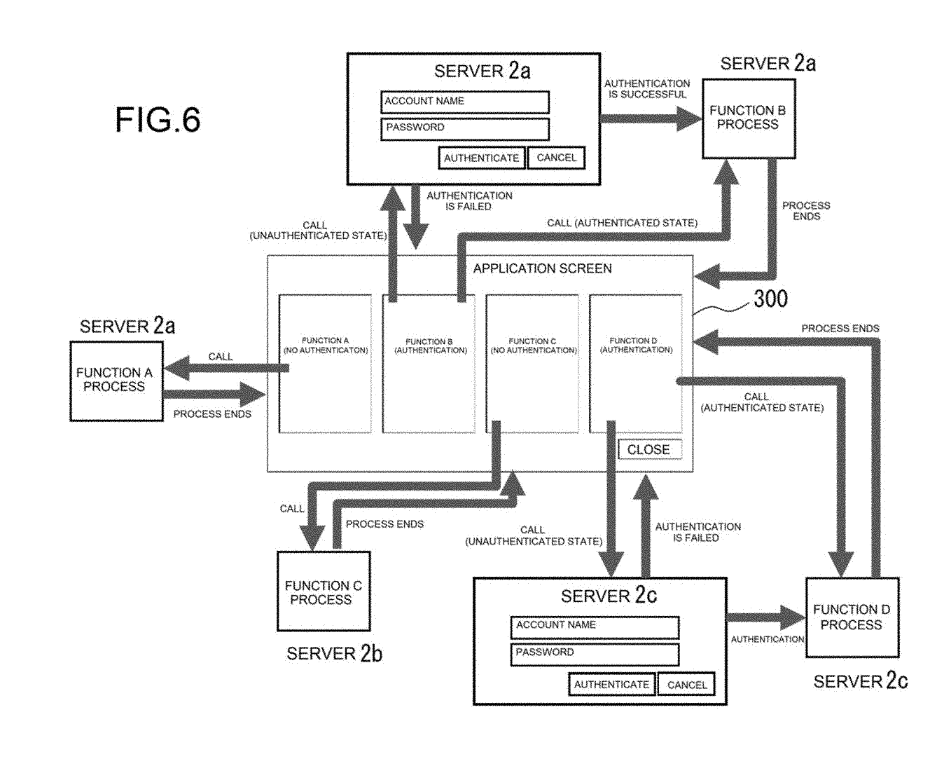

Here, a specific example of the application execution process by the image forming apparatus 1 described above will be explained using FIG. 6. In this example, each of the servers 2a, 2b and 2c have the same functions as in FIG. 1.

### (Using Function A)

The user selects function A on the application screen 300 and performs a call instruction. Here, function A is a function that does not require authentication (no authentication). Therefore, the process of function A is executed as is by the server 2a. After the process ends, the application screen 300 returns.

### (Using Function B)

The user selects function B from the application screen 300 and performs a call instruction. Here, function B is a function that requires authentication (authentication). Therefore, in the case of the unauthenticated state, a login process is performed for function B of server 2a. The user, for example, inputs an ID or account, and a password as authentication information, and the authenticated state is set. Then, the process of function B is executed. Incidentally, in the case where authentication is failed, the state remains in the unauthenticated state. After processing ends, the application screen 300 returns.

In addition, in the case of the authenticated state, a session when the login process is performed is maintained, so new user authentication is not necessary. Therefore, the process of function B is executed without performing the login process. After processing ends, the application screen 300 returns.

### (Using Function C)

The user, on the application screen 300, selects function C that does not require authentication, and after performing a calling instruction, the process of function C is executed by the server 2b. Processing then ends and the application screen 300 returns.

### (Using Function D)

The user selects function D from the application screen 300, and performs a calling instruction. Here, function D is also a function that requires authentication (authentication). Therefore, a login process is performed for function D of server 2c, and the user inputs authentication information. Then, in the case where the state is the authenticated state, the process of function D is executed, and after the process ends, the application screen 300 returns. In the case where authentication is failed, the state remains as the unauthenticated state.

In addition, in the authenticated state, the session is maintained, so the process of function D is executed. After the process ends, the application screen 300 returns.

In this way, even in the case where the image forming apparatus 1 of this embodiment calls a function requiring authentication, it is not necessary to perform operations such as authentication again, and activation and termination of the application for using each function. Therefore, it is possible to reduce the number of operation steps in comparison with the case of calling functions from individual applications.

With the configuration described above, the following effects can be obtained.

Conventionally, in a system such as in the typical technique described above, when trying to respectively call functions of a plurality of servers having different authentication information, it is necessary to perform authentication each time.

More specifically, in a conventional technique, it is necessary to respectively call functions of a plurality of servers from individual applications. Therefore, when each application is closed in order to use a different function, the connection (session) with the server ends, and the connection state becomes the same as in the logged off state. As a result, authentication must be performed again every time the application is switched, and the user must input authentication information again. In other words, in the case where the application is switched and authentication is necessary for the application to be used next, authentication must be performed every time. Therefore, it takes time for the user to perform this.

On the other hand, the image forming apparatus 1 according to an embodiment disclosed in the present disclosure is an information processing apparatus capable of calling functions of a plurality of servers 2, and includes: an integrated-arrangement unit 100 that arranges instruction areas in one application for acquiring instructions for calling functions from any one of the plurality of servers 2; an authentication-executing unit 110 that, in the case where authentication is required for a server 2 corresponding to an instruction area arranged by the integrated-arrangement unit 100, performs authentication with that server 2; and an authentication-state-changing unit 120 that controls the authentication state authenticated by the authentication-executing unit 110 in correlation with the application and/or function.

With this kind of configuration, by making it possible to use a plurality of different functions with one application, it is not necessary to perform authentication every time when respectively calling functions of a plurality of servers. Therefore, it is possible to reduce the time and effort for performing authentication that occur when using a plurality of different functions, and it is possible to improve usability.

In addition, in the image forming apparatus 1 according to an embodiment disclosed in the present disclosure, the integrated-arrangement unit 100 may arrange instruction areas of functions that required authentication by the authentication-executing unit 110, and instruction areas of functions that do not require authentication by the authentication-executing unit 110 in the application, and servers 2 corresponding to the called functions, may be different for each instruction area.

With this kind of configuration, it is possible to effectively use a plurality of different functions from one application. In other words, functions that require authentication by the user, functions that do not require authentication by the user, and functions that are provided by different servers 2 can be used in a unified way. Therefore, it becomes possible to reduce the time and effort of the user.

Moreover, in the image forming apparatus 1 according to an embodiment disclosed in the present disclosure, the authentication-state-changing unit 120 keeps the authentications state corresponding to a function, and even after calling a different function, authentication is not required again.

With this kind of configuration, it is possible to continue keeping an authentication state with a server 2 when calling a specific function. Therefore, when used to switch to a different function, by logging to the corresponding server 2 once, it becomes possible to use a specified function without inputting authentication information again. Moreover, even when a session ends for some reason, the user does not need to input authentication information every time.

Incidentally, with this kind of configuration that keeps authentication information even when an application is terminated, the user does not need to input authentication information even when terminating and activating an application again.

### OTHER EMBODIMENTS

Note that in the embodiment described above, authentication states are kept in application units. However, authentication states may be kept for each function, and the authentication state of all functions may be set to the unauthenticated state during execution of an application. In other words, the authentication-state-changing unit 120, for example, may be configured so as to arrange buttons for changing the authentication state of each server in the instruction areas, and arrange a button for changing all of the authentication states of a plurality of servers outside the instruction areas.

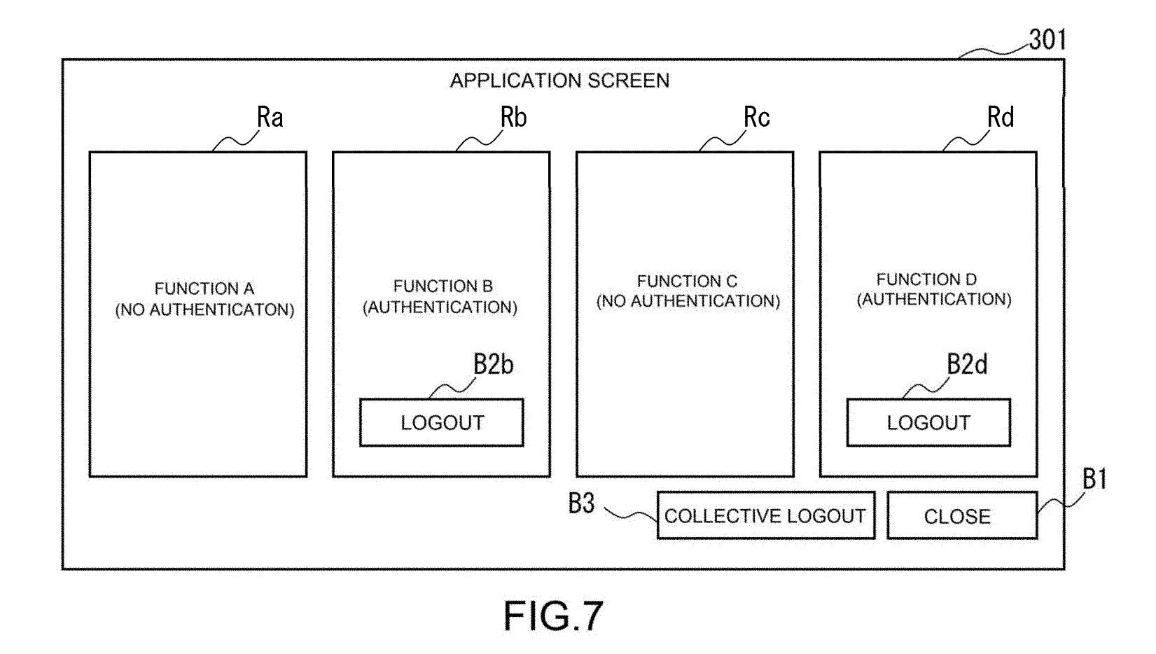

Explaining this in more detail using an example of an application screen 301 (application screen) in FIG. 7, the integrated-arrangement unit 100 and the authentication-state-changing unit 120, for example, respectively arrange buttons B2b, B2d for changing the authentication states in the instruction areas Rb and Rd. In addition, the authentication-state-changing unit 120, for example, arranges a button B3 for changing all of the authentication states of a plurality of servers 2 on the outside of the instruction areas R, Rb, Rc, and Rd of the application screen 301. In the example in FIG. 7, when each are in the authenticated state, buttons B2b and B2d are drawn as “logout”, and button B3 is drawn as “collective logout”. In other words, in this state, when the user selects and presses buttons B2b, B2d on the input unit 20, the sessions with function B of server 2a and function D of server 2c are disconnected, respectively, and the state is set to the unauthenticated state. Moreover, with button B3, similar to when the application is terminated, the sessions with all of the servers 2 in the authenticated state are disconnected, and all of the functions arranged in the application are set to the unauthenticated state.

Incidentally, in the case of being in the unauthenticated state, “login” may be drawn for buttons B2b and B2d. In this case, when buttons B2b and B2d are pressed again, the respective authentications may be performed again. In addition, in the case where any one of the functions of the instruction areas arranged in the application is in the unauthenticated state, button B3 as well may be drawn as “collective login”. In this case, with button B3 it is possible to respectively perform authentication for functions corresponding to all of the instruction areas. Moreover, in FIG. 7, even though buttons B2b and B2d are arranged inside the respective instruction areas Rb and Rd, the buttons do not absolutely need to be arranged inside the instruction areas. For example, the buttons B2b and B2d may be arranged above, below to the left, to the right, or the like of the respective instruction areas in a state correlated with the respective instruction areas, or may be arranged so as to call in a menu format.

With this kind of configuration, it is possible to change the authentication state for each function, or for all functions when executing an application. Therefore, in the case where a user desires to perform authentication for only necessary functions, or in the case where there is a concern about security of an application that is being executed, or the like, it is possible to flexibly change the authentication state.

Moreover, the technique according to the present disclosure can also be applied to an information-processing apparatus other than an image forming apparatus. In other words, a configuration is also possible that uses a server or the like that separately connects to a network scanner or scanner by a USB or the like.

In the typical technique described above, when trying to respectively call functions of a plurality of servers, it is necessary to perform authentication every time.

With the technique according to the present disclosure, instruction areas for acquiring instructions that call a function of any one of a plurality of servers are arranged in one application, authentication corresponding to an instruction area is executed, and the authentication state is controlled in correlation with the application and/or function. As a result, an information processing apparatus is provided that does not need to perform authentication every time functions of servers are called.

Moreover, the configurations and operations of the above-described embodiments are examples, and needless to say can be appropriately changed and executed within a range that does not depart from the gist of the present disclosure.

What is claimed is:

1. An information processing apparatus capable of calling functions of a plurality of servers, comprising:
an integrated-arrangement unit that arranges instruction areas in one application for acquiring instructions for calling the functions from any one of the plurality of servers;
an authentication-executing unit that, in the case where authentication is required in the function for a server corresponding to the instruction areas arranged by the integrated-arrangement unit, performs authentication with that server; and
an authentication-state-changing unit that controls the authentication state authenticated by the authentication-executing unit in correlation with the application and/or the function.

2. The information processing apparatus according to claim 1, wherein
the integrated-arrangement unit
may arrange the instruction areas of the functions that required authentication by the authentication-executing unit, and the instruction areas of the functions that do not require authentication by the authentication-executing unit in the application, and
the servers corresponding to the called functions,
may be different for each instruction area.

3. The information processing apparatus according to claim 1, wherein
the authentication-state-changing unit keeps the authentications states corresponding to the functions, and even after calling a different function, the authentication is not required again.

4. The information processing apparatus according to claim 1, wherein
the authentication-state-changing unit
arranges buttons for changing the authentication state of each of the servers in the instruction areas, and
arranges a button for changing all of the authentication states of the plurality of servers outside the instruction areas.

5. An image forming apparatus, comprising
the information processing apparatus according to claim 1.

6. An information processing method that is executed by an information processing apparatus capable of calling functions of a plurality of servers, causes the information processing apparatus to:
arrange instruction areas in one application for acquiring instructions for calling the functions from any one of the plurality of servers;
in the case where authentication is required in the function for a server corresponding to the arranged instruction areas, perform authentication with that server; and
control the authenticated authentication state in correlation with the application and/or the function.
